(19) United States
(12) Patent Application Publication
(10) Pub. No.: US 2007/0180709 A1
(43) Pub. Date: Aug. 9, 2007

(54) Circular saw with rotatable handle

(76) Inventors: Gianni Borinato, Schio (IT); Paolo Andriolo, Suzhou (CN)

Correspondence Address: FULWIDER PATTON LEE & UTECHT, LLP, 200 OCEANGATE, SUITE 1550, LONG BEACH, CA, 90802, US

(21) Appl. No.: 11/645,890

(22) Filed: Dec. 27, 2006

Related U.S. Application Data
(63) Continuation-in-part of application No. 11/169,559, filed on Jun. 29, 2005.

(30) Foreign Application Priority Data
Jan. 4, 2006 (CN) 200610005236.X

(51) Int. Cl. B23D 45/16

(52) U.S. Cl. 30/388

(57) ABSTRACT

The present invention relates to a power tool which comprises a rotary tool for working on a work piece and a motor having a longitudinal shaft axis. A motor housing supports the motor and a transmission mechanism for transferring energy from the motor to the rotary tool. A handle assembly is provided for moving the power tool with respect to the work piece. The handle assembly has a switch positioned thereon to electrically connect the motor to a power source. The handle assembly is rotatable relative to the rotary tool housing during operation of the motor.

### CROSS-REFERENCES TO RELATED APPLICATIONS

This application claims priority to Chinese Patent Application No. 200610005236.x filed Jan. 4, 2006, which is a continuation-in-part of U.S. patent application Ser. No. 11/169,595, filed Jun. 29, 2005.

### BACKGROUND OF THE INVENTION

The present invention relates to a power tool (preferably a circular saw) having a novel handle assembly.

Power tools are generally composed of a housing or main body inside which there is arranged an electric motor having a shaft connected to a rotary tool element via a gear system to reduce speed. The housing generally includes a handgrip to allow a user to hold and drive the tool element. In most cases, the main body is provided with a base plate to support the machine on a work-piece during operation. In a circular saw, the housing is adjustable relative to the base plate to change the depth of cut of the saw blade. In the case of (for example) a circular saw or a bench grinder, the tool element (e. g. a circular blade) can be partially housed by a housing to protect the user during operation.

Power tools are generally composed of a housing or main body inside which there is arranged an electric motor having a shaft connected to a rotary tool element via a gear system to reduce speed. The housing generally includes a handgrip to allow a user to hold and drive the tool element. In most cases, the main body is provided with a base plate to support the machine on a work-piece during operation. In a circular saw, the housing is adjustable relative to the base plate to change the depth of cut of the saw blade. In the case of (for example) a circular saw or a bench grinder, the tool element (e. g. a circular blade) can be partially housed by a housing to protect the user during operation.

Almost all commercial power tools nowadays have the handgrip integrally formed with the housing and the rotary tool element. Such power tools have the drawback that during operation on a vertical or an oblique work piece or on a very long work piece, the operator has to move a relatively long distance thereby extending his arm and hand. The fixed position of the move a relatively long distance thereby extending his arm and hand. The fixed position of the handgrip obstructs the manual control of the machine and the accuracy of the work. It is disadvantageous to productivity. Most importantly, it may be dangerous to the operator.

The same drawbacks arise when the depth of the cut of a saw blade is adjusted. In this case, while the position of the tool element relative to the shoe plate is changed, the position of the handgrip changes too resulting in the drawbacks mentioned above.

U.S. Pat. No. 4,516,324 discloses a circular saw which has a one-piece housing and a rotatable handgrip. The handgrip can be positioned in two positions, a first position being a “push position” wherein the tool is pushed straight in the cutting direction and a second position being a “top position” wherein the handgrip is adjusted vertically on the tool. This arrangement gives the user the option to change the handgrip between two positions only. Moreover, the steps for adjusting the handgrip between the two positions are quite complex and lengthy. In practice it is necessary to unplug the power cord for safety reasons, to unlock the handgrip, to adjust its position, to lock the handgrip, to plug the power cord in again and so on. Such a lengthy operation may lead the user not to change the handgrip position at all.

U.S. Pat. No. 6,588,112 discloses a circular saw in which the motor housing and the blade housing form a unit and are fixed to a base plate. A motor in a motor housing drives the saw blade rotatably around a certain axis. A handle on which is assembled a switch is rotatably supported on the motor housing. The circular saw further comprises a locking device for fixing the handle on the motor housing. In order to adjust the handle, the operator loosens the locking device, rotates the handle to a desired position and then tightens the locking device to secure the handle to the motor housing. With safety in mind, the circular saw further comprises a control device which consists of a lever and spring disposed between the locking device and the switch. The control device ensures that when the locking device is loosened, the handle is rotatable and power cannot pass through the switch to the motor so that the motor is momentarily disabled. In contrast, when the locking device is tightened, the handle is secured on the motor housing and cannot rotate relative to the motor housing so that power can pass through the switch to the motor and the motor can work. A disadvantage of this arrangement is that the operating steps are complex and time consuming and efficiency is very low. Additionally over prolonged periods, in the mechanism itself as well as in other parts that are subjected to continued stress, a degree of play may be generated. Excessive play between the lever and the switch may compromise the functionality of the machine and possibly the safety which may constitute a risk to the user. Furthermore, the electric cable that connects the power switch (which is arranged on a movable handgrip and which rotates (pivots) along with the handgrip) to the motor is subjected to torsion and bending each time the handgrip is adjusted to a new position. Even if a soft and flexible cable is used, over time there is an increased risk of the cable breaking leading to the possibility of a dangerous electrical short circuit.

### SUMMARY OF THE INVENTION

An object of the present invention is to provide a circular saw with a rotatable handle which can be rotated to a desired position when the motor is working.

To achieve the above object, the present invention provides a power tool (preferably a circular saw) which comprises a tool (e. g. a rotary tool) for working on a work piece, a rotary motor having a longitudinal shaft axis, a motor housing for supporting the rotary motor, a transmission mechanism for transferring energy from the rotary motor to the tool and a handle assembly for moving the power tool with respect to the work piece. The handle assembly with a switch element positioned thereon is supported by the motor housing. The switch element electrical connects the rotary motor to a power source and the handle assembly is rotatable relative to the tool housing during operation of the rotary motor.

In a preferred embodiment of the present invention, the handle assembly comprises a handle housing which is mounted (e. g. rotationally mounted) on the motor housing. Typically the motor housing is at least partly nested in the handle housing. The handle assembly has a connecting element attached thereto for engaging a conductive rail of the motor housing to allow power to be transferred to the rotary motor and cause the handle assembly to rotate relative to the motor housing or tool housing during operation of the motor. A damping member for slowing down the rotation of the handle assembly may be interposed between the tool housing and the handle housing.

In a preferred embodiment of the invention, the power tool for working on a workpiece comprises: a) a rotary tool, b) a rotary tool housing which accommodates and supports the rotary tool, c) a rotary motor with a motor shaft defining a longitudinal shaft axis Y which drives the rotary tool, d) a motor housing for supporting the rotary motor, e) a transmission element coupling the rotary motor to the rotary tool, f) a switch mounted on the handle assembly for electively electrically connecting the rotary motor to a power source to operate the power tool and g) a handle assembly for moving the rotary tool with respect to the workpiece, wherein the handle assembly is selectively rotatable relative to the rotary tool housing during operation of the rotary motor.

The handle assembly can be adjusted to a desired position during operation of the motor which makes it easy to operate and saves time. Working efficiency and safety are improved.

Preferably the power tool is a circular saw.

Preferably the rotary tool is a rotary saw blade.

Preferably the rotary tool has an axis X which is essentially parallel to the longitudinal shaft axis Y.

Preferably the handle assembly is rotatable about the longitudinal shaft axis Y or an axis substantially parallel thereto.

In a preferred embodiment, a first end of the motor housing is externally threaded and a retaining cap is threadedly engageable on the first end of the motor housing to releasably clamp the handle housing. Preferably a leading edge of the retaining cap axially engages a terminal edge of the handle housing or the motor housing. The retaining cap may be cup-shaped.

In a preferred embodiment, a second end of the motor housing is fixed to the rotary tool housing and the handle assembly is rotatably mounted on the motor housing.

In a preferred embodiment, the motor housing and the handle assembly are a monolithic unit which is selectively rotatable relative to the rotary tool housing during operation of the rotary motor.

In a preferred embodiment, the handle assembly comprises a handle housing rotatably mounted on the motor housing, a first handle part fixed to the handle housing or the motor housing and a second handle part fixed to the handle housing.

The handle assembly may comprise a first substantially U-shaped handle part (eg handgrip) integral with or secured to the handle housing or the motor housing and a second substantially U-shaped handle part (eg handgrip) integral with or secured to the handle housing. The first handle part may have a first handle axis a which is substantially perpendicular to the longitudinal shaft axis Y. The second handle part may have a second handle axis b which is substantially parallel to the longitudinal shaft axis Y. With respect to the longitudinal shaft axis Y, the first handle part is typically substantially perpendicular to the second handle part.

Preferably the handle housing is substantially cylindrical with an internal cavity for receiving at least a part (e. g. the whole) of the motor housing.

Preferably an annular rib is formed prominently on the external surface of the motor housing and an internal surface of the handle housing slidably engages the annular rib such that when the handle assembly is rotated, the internal surface slides along the annular rib. Two or more (preferably two) annular ribs may be formed on the external surface of the motor housing. The or each annular rib may be integrally formed on the motor housing or tight fitted thereon. The internal surface may be tapered.

Preferably the motor housing has at least one prominent conductive rail to electrically connect to the rotary motor. Particularly preferably formed in the exterior surface of the motor housing is a part circumferential recess (e. g. a rectangular recess) extending along which are a plurality of conductive rails spaced apart in a direction substantially parallel to the longitudinal shaft axis Y. Each conductive rail is typically made of conductive metal such as copper. Preferably a pair of conductive rails is spaced apart in a direction substantially parallel to the longitudinal shaft axis Y (e. g. side-by-side).

In a preferred embodiment, a connecting element between the handle assembly and the conductive rail via which the switch is selectively electrically connected to the rotary motor.

Preferably the connecting element comprises a base which is secured to an internal surface of the handle assembly, a plurality of elastic metal pieces mounted on the base, a plurality of wires each having a first end connected to the switch and a second end connected to one of the plurality of elastic metal elements and a contact attached to each elastic metal piece, wherein the contact is engaged with the conductive rail.

In a preferred embodiment, a damping member for retarding the rotation of the handle assembly relative to the rotary tool housing is disposed between the rotary tool housing and the handle housing. Preferably the damping member is a ring brake or a shock absorber coupling the rotary tool housing and the handle housing to retard the rotation of the handle housing relative to the rotary tool housing. Typically the ring brake is made of the material which can produce friction such as silicon grease.

### BRIEF DESCRIPTION OF THE DRAWINGS

FIG. 1 is a perspective view of the circular saw according to a first embodiment of the present invention;

FIG. 2 is an exploded view of the circular saw according to the first embodiment of the present invention;

FIG. 3 is a cross sectional view along line Y-Y towards direction V of FIG. 1;

FIG. 4 is a perspective view of the circular saw according to a second embodiment of the present invention;

FIGS. 5a-e are views of the circular saw according to a third embodiment of the present invention; and

FIG. 6 is a perspective view of the circular saw according to a fourth embodiment of the present invention.

### DETAILED DESCRIPTION OF THE PREFERRED EMBODIMENTS

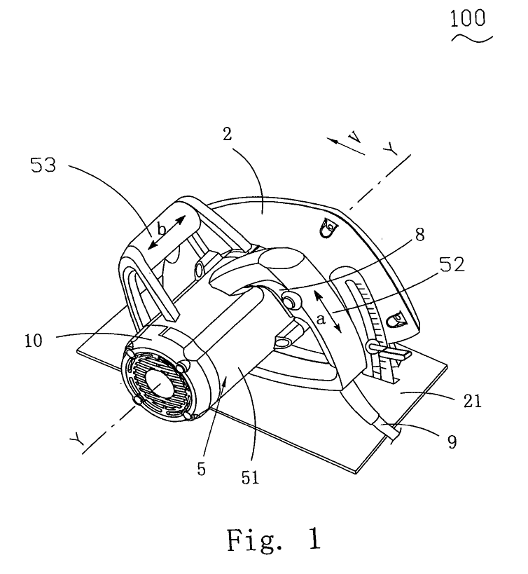

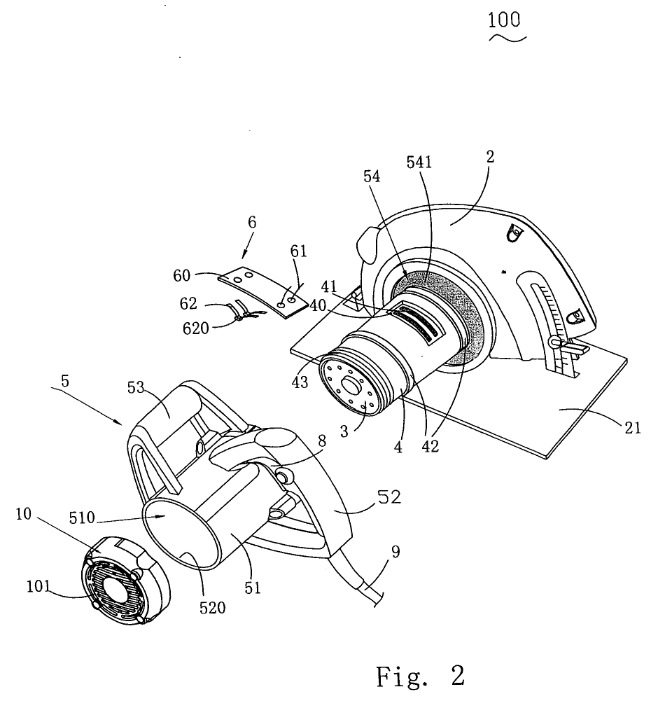

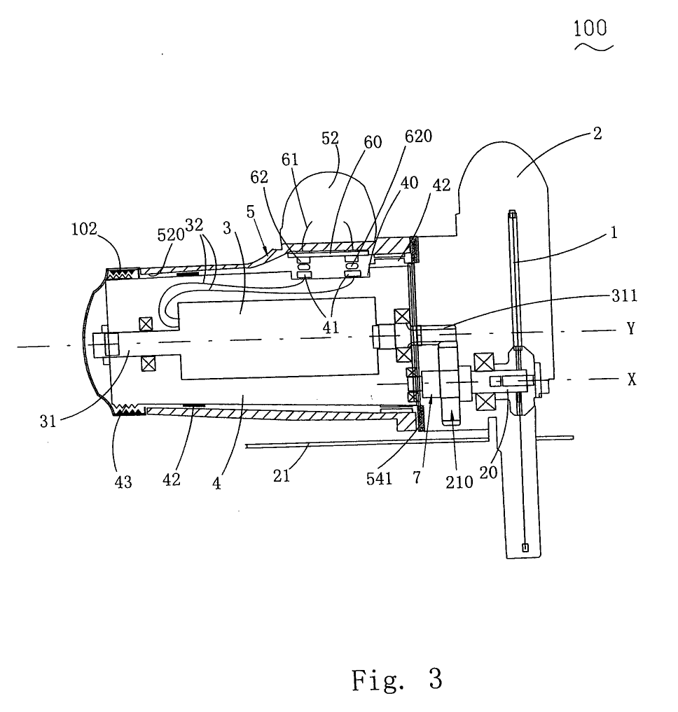

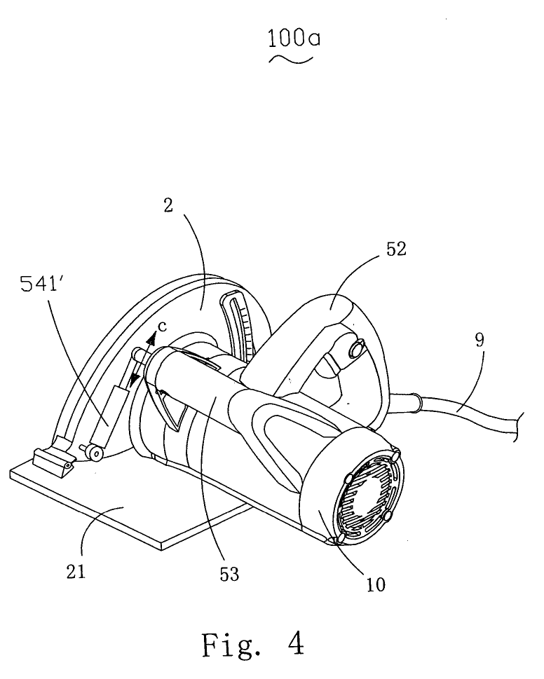

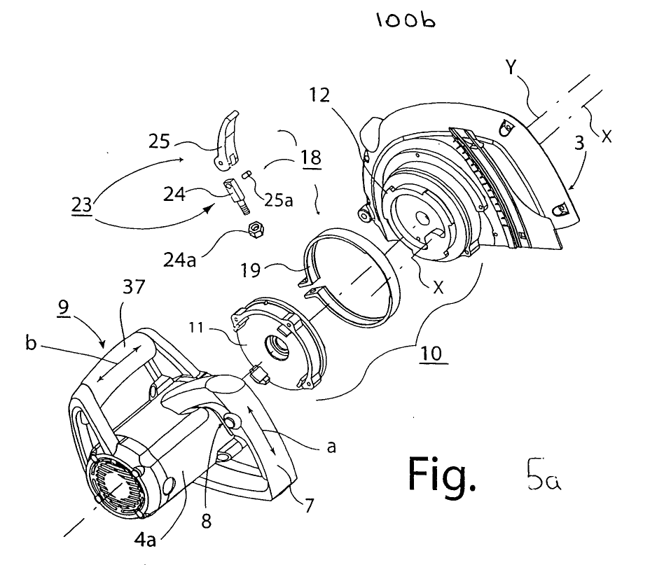

Referring to FIGS. 1 to 3, a first embodiment of the present invention is a circular saw 100 which comprises a rotary saw blade 1 for working on a work piece (not shown). The rotary saw blade 1 has a rotational axis X and is accommodated in and supported by a saw blade housing 2. The saw blade housing 2 is mounted on and near to an edge of a base plate 21. A rotary motor 3 with a motor shaft 31 defining a longitudinal shaft axis Y drives the rotary saw blade 1. The rotary motor 3 is housed in a motor housing 4 which is adjacent and fixed to the saw blade housing 2. A transmission element 7 couples the rotary motor 3 to the rotary saw blade 1. The transmission element 7 comprises a pinion 311 formed at an end of the motor shaft 31. The pinion 311 drives a gear mechanism 210 which is connected to a blade shaft 20 on which is mounted the rotary saw blade 1. In this embodiment, the longitudinal shaft axis Y is substantially parallel to the rotational axis X (see FIG. 3).

A handle assembly 5 is provided so that the circular saw 100 is portable and may be moved relative to the work piece. The handle assembly 5 comprises a handle housing 51, a first substantially U-shaped handle part 52 secured to the handle housing 51 and a second substantially U-shaped handle part 53 secured to the handle housing 51. The handle housing 51 is substantially a hollow cylinder with an internal cavity 510 for receiving the motor housing 4. The first handle part 52 has a first handle axis a which is spaced apart from and is substantially perpendicular to the longitudinal shaft axis Y. The second handle part 53 has a second handle axis b which is substantially parallel to the longitudinal shaft axis Y. With respect to the longitudinal shaft axis Y, the first handle part 52 is substantially perpendicular to the second handle part 53. The second handle part 53 is disposed adjacent to the middle section of the first handle part 52. The operator may hold the circular saw 100 with both the first and second handle parts 52, 53 during operation.

A first end of the motor housing 4 is fixed to the saw blade housing 2. A second end of the motor housing 4 has an external screw thread 43 formed on its outer surface. A part circumferential recess 40 is formed in the exterior surface of the motor housing 4. The recess 40 is substantially rectangular. A pair of axially spaced apart conductive rails 41 made of copper are positioned side-by-side inside the recess 40. A wire 32 is connected to the basal face of each conductive rail 41 to electrically connect to the rotary motor 3. A pair of annular ribs 42 are formed prominently on the outer surface of the motor housing 4 either side of the recess 40. An internal tapered surface 520 of the handle housing 51 slidably engages the annular ribs 42 such that when the handle assembly 5 in which the motor housing 4 is nested is rotated, the tapered surface 520 slides along the annular ribs 42.

A switch 8 is mounted on the first handle part 52 and is electrically connected to an external power source through an electric cable 9. The switch 8 is selectively electrically connected to the rotary motor 3 via a connecting element 6. The connecting element 6 comprises an insulating base 60 which is secured onto the internal tapered surface 520 of the handle housing 51. Wires 61 connected to the switch 8 are positioned on the insulating base 60. A pair of elastic metal plates 62 are attached to the insulating base 60. A first end of each elastic metal plate 62 is connected to the wire 61 and a second end is secured to the insulating base 60. A contact 620 is positioned in the middle portion of each elastic metal plate 62. When the handle assembly 5 is sleeved onto the motor housing 4, each contact 620 engages a conductive rail 41 to electrically connect the switch 8 and the connecting element 6 to the rotary motor 3.

A damping member 54 is interposed between the handle housing 51 and the saw blade housing 2. The damping member 54 can produce a substantially uniform frictional force which retards the rotary speed of the handle assembly 5. In this embodiment, the damping member 54 is a ring brake 541 made of silicone.

A cup-shaped retaining cap 10 fitted threadedly on the end of the motor housing 4 has a plurality of air vents 101 for cooling the rotary motor 3. An internal screw thread 102 formed on the internal surface of the retaining cap 10 meshes with the external screw thread 43. Rotating the retaining cap 10 causes it to move along the axis Y. By rotating and moving the retaining cap 10 along the motor housing 4 towards the saw blade housing 2, the handle housing 51 is clamped between the retaining cap 10 and the ring brake 541. When the handle housing 51 is tightly clamped, the handle assembly 5 is non-rotatable. By rotating and moving the retaining cap 10 along the motor housing 4 away from the saw blade housing 2, the handle housing 51 is loosened and the handle assembly 5 is rotatable. The frictional force between the handle housing 51 and the ring brake 541 allows the handle assembly 5 to be rotated to a desired position slowly. The rotary motor 3 is kept operational when rotating the handle assembly 5. No wires are interposed between the handle housing 51 and the motor housing 4 so it will be safe to operate with less tendency to short circuit even after lengthy operation.

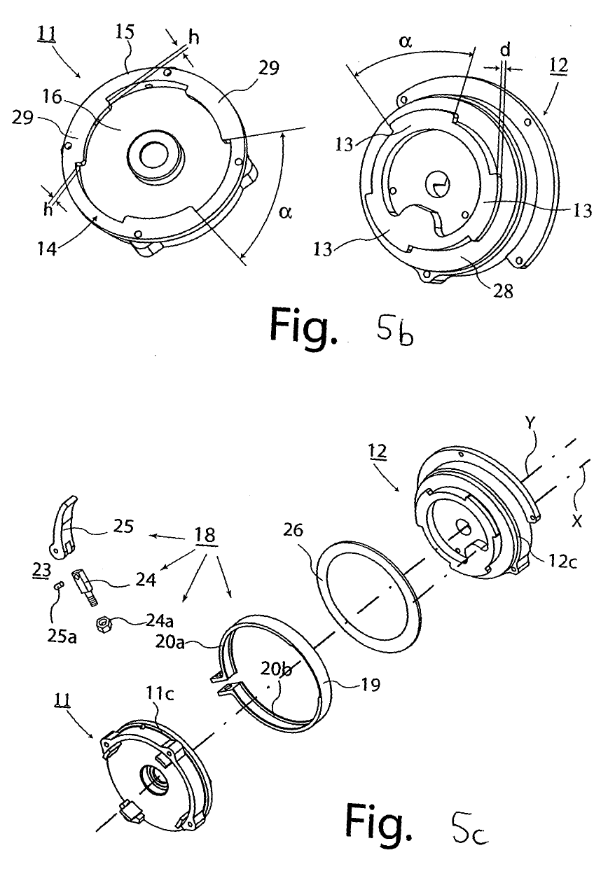

The second embodiment of the present invention illustrated in FIG. 4 is a circular saw 100a which is similar to the circular saw 100 of the first embodiment of the present invention described above. However in the second embodiment, the ring brake 541 is replaced by a shock absorber 541′. A first end of the shock absorber 541′ is connected to the saw blade housing 2 and a second end is connected to the handle housing 51. The shock absorber 541′ moves in direction c to retard the rotary speed of the handle assembly 5 during adjustment.

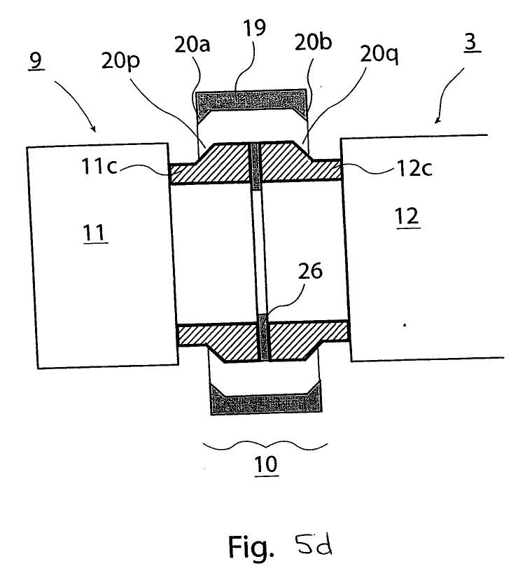

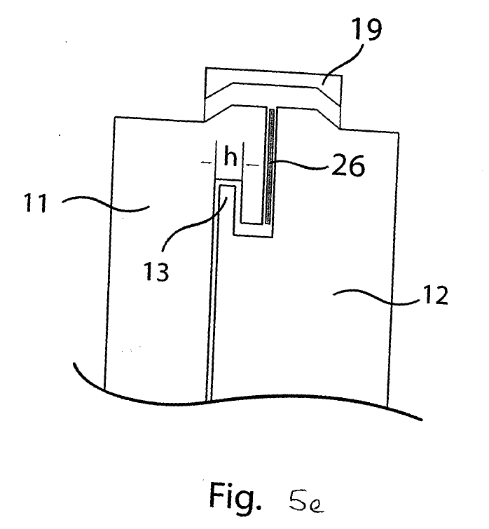

The third embodiment of the present invention illustrated in FIGS. 5a-e is a circular saw 100b. In contrast to the circular saw 100 and 100a of the first and second embodiments of the invention described above however, the handle assembly and motor housing integrally form a monolithic unit 9 which is rotatable relative to the saw blade housing 3.

As shown in detail in FIGS. 5a-e, the circular saw 100b is equipped with a coupling member 10 for operatively coupling the monolithic unit 9 to the saw blade housing 3. The coupling member 10 is of the bayonet-type containing a female element 11 and a male element 12. The female element 11 is connected to the monolithic unit 9 whereas the male element 12 is connected to the saw blade housing 3. Both the male and female element 11, 12 are essentially ring-shaped. A first coupling portion 11c is an integral part of the female element 11. Correspondingly, a second coupling portion 12c is an integral part of the male element 12.

From FIG. 5i b, it is evident that the female element 11 has three recesses 14 provided in a flange 15 which extends from a cylindrical piece 16 and which are angularly offset from each other (by an angle) with three teeth 29 of predetermined height h arranged in-between. It will also be evident that the male element 12 has three protrusions 13 which are angularly equidistant (by an amount corresponding to angle) and which have a predetermined thickness and three recesses therebetween. The height h of the teeth 29 measured from the cylindrical piece 16 is at least the same as the thickness d of each protrusion 13. The protrusions 13 enter the recesses 14 of the female element 11 by motion along the longitudinal shaft axis Y. After insertion and rotation of the male element 12 by approximately 60° around the longitudinal shaft axis Y, each of the protrusions 13 will be captured by and engaged behind one of the teeth 29 of the female element 11. In order to avoid accidental unlocking of the protrusions 13 from the corresponding recesses 14 during rotation, the male element 12 and the female element 11 may comprise angle delimiters (not shown in the Figures).

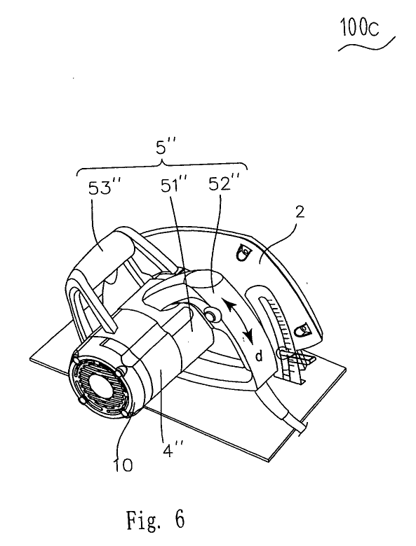

The circular saw 1 is provided with a locking member 18 to prevent the male element 12 and the female element 11 becoming unlocked and separated. The locking member 18 comprises a split ring 19 which is open when not in use. The split ring 19 has on its inner circumference first and second lateral annular extensions 20a, 20b adapted to engage first and second annular recesses 20p, 20q on the outer circumferential surface of the first and second coupling portions 11c, 12c, respectively (see FIGS. 6 and 7). The split ring 19 is slightly flexible and may be made of steel. The recesses 20p, 20q and the extensions 20a, 20b all have oblique walls. When the split ring 19 is closed, a pressure is exerted on the oblique walls. In order to adjust the locking force, the split ring 19 has a screw fastener 23. In particular, the screw fastener 23 comprises a lever 25 attachable by a pin 25a to a threaded holder 24. The end portion of the holder 24 can be screwed on the bent end pieces of the split ring 19 by means of a nut 24a.

A sliding ring 26 is located between the coupling portions 11c, 12c and in the interior of the split ring 19 between extensions 20a, 20b for a sliding rotation between the unit 9 and the safety housing 3. In the illustrated embodiment, the sliding ring 26 is made from a viscose-elastic material such as rubber. Rotation stops as soon as the operator of the circular saw 100b no longer exercises a rotational force on the first and second handle parts 7, 37. The viscose sliding ring 26 between the surfaces of the male element 12 and the female element 11 ensures a smooth and safe motion as the operator seeks to identify a more comfortable sawing position. For this purpose, it is an advantageous feature of the present invention that the user can rotate the first and second handle parts 7, 37 even during operation of the circular saw 100b. In other words, the operator can change the position of the first and second handle parts 7, 37 during operation of the circular saw 100b in a simple and safe manner.

Referring to FIG. 6, the fourth embodiment of the present invention is a circular saw 100c which is similar to the circular saws 100 and 100a of the first and second embodiment of the present invention. The difference between circular saw 100c and 100, 100a is that the handle assembly 5″ comprises a handle housing 51″, a first handle 52″ fixed on the handle housing 51″ and a second handle 53″ fixed on the motor housing 4″. The handle housing 51″ is sleeved on the motor housing 4″ and is rotatable relative to it. By rotating and moving the retaining cap 10 towards the saw blade housing 2, the handle housing 51″ is tightly clamped between the motor housing 4″ and the saw blade housing 2. When the handle housing 51″ is tightly clamped, the first handle 52″ is non-rotatable. By rotating and moving the retaining cap 10 away from the saw blade housing 2, the handle housing 51″ is loosened and the first handle 52″ is rotatable to a desired position. Again the motor can be keep working when adjusting the handle assembly 5″ to a more comfortable position.

We claim:

1. A power tool for working on a workpiece comprising:
a) a rotary tool,
b) a rotary tool housing which accommodates and supports the rotary tool,
c) a rotary motor with a motor shaft defining a longitudinal shaft axis Y which drives the rotary tool,
d) a motor housing for supporting the rotary motor,
e) a transmission element coupling the rotary motor to the rotary tool,
f) a switch mounted on the handle assembly for selectively electrically connecting the rotary motor to a power source to operate the power tool; and
g) a handle assembly for moving the rotary tool with respect to the workpiece, wherein the handle assembly is selectively rotatable relative to the rotary tool housing during operation of the rotary motor.

2. The power tool according to claim 1, wherein the rotary tool has an axis X which is essentially parallel to the longitudinal shaft axis Y.

3. The power tool according to claim 1, wherein the handle assembly is rotatable about the longitudinal shaft axis Y or an axis substantially parallel thereto.

4. The power tool according to claim 1, wherein a first end of the motor housing is externally threaded and a retaining cap is threadedly engageable on the first end of the motor housing to releasably clamp the handle housing.

5. The power tool according to claim 4, wherein a leading edge of the retaining cap axially engages a terminal edge of the handle housing or the motor housing.

6. The power tool according to claim 1, wherein a second end of the motor housing is fixed to the rotary tool housing and the handle assembly is rotatably mounted on the motor housing.

7. The power tool according to claim 1, wherein the motor housing and the handle assembly are a monolithic unit which is selectively rotatable relative to the rotary tool housing during operation of the rotary motor.

8. The power tool according to claim 1, wherein the handle assembly comprises:
a handle housing rotatably mounted on the motor housing,
a first handle part fixed to the handle housing or the motor housing and
a second handle part fixed to the handle housing.

9. The power tool according to claim 8, wherein the handle housing is substantially cylindrical with an internal cavity for receiving at least a part of the motor housing.

10. The power tool according to claim 8 wherein an annular rib is formed prominently on the external surface of the motor housing and an internal surface of the handle housing slidably engages the annular rib such that when the handle assembly is rotated, the internal surface slides along the annular rib.

11. The power tool according to claim 8, wherein the motor housing has at least one prominent conductive rail to electrically connect to the rotary motor.

12. The power tool according to claim 11 wherein formed in the exterior surface of the motor housing is a part circumferential recess extending along which are a plurality of conductive rails spaced apart in a direction substantially parallel to the longitudinal shaft axis Y.

13. The power tool according to claim 12, wherein each conductive rail is made of conductive metal.

14. The power tool according to claim 11 further comprising:
a connecting element between the handle assembly and the conductive rail via which the switch is selectively electrically connected to the rotary motor.

15. The power tool according to claim 14, wherein the connecting element comprises:
a base which is secured to an internal surface of the handle assembly,
a plurality of elastic metal pieces mounted on the base,
a plurality of wires each having a first end connected to the switch and a second end connected to one of the plurality of elastic metal elements; and
a contact attached to each elastic metal piece, wherein the contact is engaged with the conductive rail.

16. The power tool according to claim 8, wherein a damping member for retarding the rotation of the handle assembly relative to the rotary tool housing is disposed between the rotary tool housing and the handle housing.

17. The power tool according to claim 16, wherein the damping member is a ring brake.

18. The power tool according to claim 16, wherein the damping member is a shock absorber coupling the rotary tool housing and the handle housing to retard the rotation of the handle housing relative to the rotary tool housing.
